(19) United States
(12) Patent Application Publication
(10) Pub. No.: US 2015/0277644 A1
(43) Pub. Date: Oct. 1, 2015

(54) INTERACTIVE INPUT SYSTEM AND PEN TOOL THERFOR

(71) Applicant: SMART Technologies ULC, Calgary (CA)

(72) Inventors: STEPHEN BOLT, Kanata (CA); SEAN THOMPSON, Calgary (CA)

(21) Appl. No.: 14/739,308

(22) Filed: Jun. 15, 2015

Related U.S. Application Data
(63) Continuation of application No. 13/750,087, filed on Jan. 25, 2013.
Application No. 13/750,087 is a continuation of application No. 12/118,535, filed on May 9, 2008, now abandoned.

(51) Int. Cl. G06F 3/041; H04N 5/225; G06F 3/147; G06F 3/0354; G06F 3/042

(52) U.S. Cl. CPC G06F 3/0412; G06F 3/03545; G06F 3/0428; G06F 3/147; H04N 5/225; G06F 2203/04104

(57) ABSTRACT

A pen tool for use with an interactive input system comprises an elongate body, at least one switch assembly accommodated by the body and a controller accommodated by the body and communicating with the at least one switch assembly. The at least one switch assembly is actualable when the pen tool is brought into contact with an input surface of the interactive input system. The controller is responsive to actuation of the at least one switch assembly. The at least one switch assembly comprises a contact circuit and a plunger assembly having a conductive element thereon that is generally aligned with the contact circuit. The plunger assembly is moveable into the body to bring the conductive element into contact with the contact circuit thereby actuate the at least one switch assembly.

This application is a continuation of U.S. patent application Ser. No. 13/750,087, filed Jan. 25, 2013, which is a continuation of U.S. patent application Ser. No. 12/118,535, filed May 9, 2008, now abandoned, the contents of both incorporated herein.

### FIELD OF THE INVENTION

The present invention relates to an interactive input system and to a pen tool therefor.

### BACKGROUND OF THE INVENTION

Interactive input systems that allow users to input ink into an application program using an active pointer (eg. a pointer that emits light, sound or other signal), a passive pointer (eg. a finger, cylinder or other object) or other suitable input device such as for example, a mouse or trackball, are well known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 and in U.S. Patent Application Publication No. 2004/0179001 assigned to SMART Technologies ULC of Calgary, Alberta, Canada, assignee of the subject application, the contents of which are incorporated by reference; touch systems comprising touch panels employing electromagnetic, capacitive, acoustic or other technologies to register pointer input; tablet personal computers (PCs); laptop PCs; personal digital assistants (PDAs); and other similar devices.

Above-incorporated U.S. Pat. No. 6,803,906 to Morrison et al. discloses a touch system that employs machine vision to detect pointer interaction with a touch surface on which a computer-generated image is presented. A rectangular bezel or frame surrounds the touch surface and supports digital cameras at its corners. The digital cameras have overlapping fields of view that encompass and look generally across the touch surface. The digital cameras acquire images looking across the touch surface from different vantages and generate image data. Image data acquired by the digital cameras is processed by on-board digital signal processors to determine if a pointer exists in the captured image data. When it is determined that a pointer exists in the captured image data, the digital signal processors convey pointer characteristic data to a master controller, which in turn processes the pointer characteristic data to determine the location of the pointer in (x,y) coordinates relative to the touch surface using triangulation. The pointer coordinates are conveyed to a computer executing one or more application programs. The computer uses the pointer coordinates to update the computer-generated image that is presented on the touch surface. Pointer contacts on the touch surface can therefore be recorded as writing or drawing or used to control execution of application programs executed by the computer.

U.S. Patent Application Publication No. 2004/0179001 to Morrison et al. discloses a touch system and method that differentiates between passive pointers used to contact a touch surface so that pointer position data generated in response to a pointer contact with the touch surface can be processed in accordance with the type of pointer used to contact the touch surface. The touch system comprises a touch surface to be contacted by a passive pointer and at least one imaging device having a field of view looking generally along the touch surface. At least one processor communicates with the at least one imaging device and analyzes images acquired by the at least one imaging device to determine the type of pointer used to contact the touch surface and the location on the touch surface where pointer contact is made. The determined type of pointer and the location on the touch surface where the pointer contact is made are used by a computer to control execution of an application program executed by the computer.

In order to determine the type of pointer used to contact the touch surface, in one embodiment a curve of growth method is employed to differentiate between different pointers. During this method, a horizontal intensity profile (HIP) is formed by calculating a sum along each row of pixels in each acquired image thereby to produce a one-dimensional profile having a number of points equal to the row dimension of the acquired image. A curve of growth is then generated from the HIP by forming the cumulative sum from the HIP.

Although passive touch systems provide some advantages over active touch systems and work extremely well, using both active and passive pointers in conjunction with a touch system provides more intuitive input modalities with a reduced number of processors and/or processor load.

Camera-based touch systems having multiple input modalities have been considered. For example, U.S. Pat. No. 7,202,860 to Ogawa discloses a camera-based coordinate input device allowing coordinate input using a pointer or finger. The coordinate input device comprises a pair of cameras positioned in the upper left and upper right corners of a display screen. The field of view of each camera extends to a diagonally opposite corner of the display screen in parallel with the display screen. Infrared emitting diodes are arranged close to the imaging lens of each camera and illuminate the surrounding area of the display screen. An outline frame is provided on three sides of the display screen. A narrow-width retro-reflection tape is arranged near the display screen on the outline frame. A non-reflective black tape is attached to the outline frame along and in contact with the retro-reflection tape. The retro-reflection tape reflects the light from the infrared emitting diodes allowing the reflected light to be picked up as a strong white signal. When a user's finger is placed proximate to the display screen, the finger appears as a shadow over the image of the retro-reflection tape.

The video signals from the two cameras are fed to a control circuit, which detects the border between the white image of the retro-reflection tape and the outline frame. A horizontal line of pixels from the white image close to the border is selected. The horizontal line of pixels contains information related to a location where the user's finger is in contact with the display screen. The control circuit determines the coordinates of the touch position, and the coordinate value is then sent to a computer.

When a pen having a retro-reflective tip touches the display screen, the light reflected therefrom is strong enough to be registered as a white signal. The resulting image is not discriminated from the image of the retro-reflection tape. However, the resulting image is easily discriminated from the image of the black tape. In this case, a line of pixels from the black image close to the border of the outline frame is selected. Since the signal of the line of pixels contains information relating to the location where the pen is in contact with the display screen. The control circuit determines the coordinate value of the touch position of the pen and the coordinate value is then sent to the computer.

Although Ogawa is able to determine the difference between two passive pointers, the number of input modalities is limited to relatively few types of pointers such as pen and finger inputs. More pointers are capable using polarization techniques; however, these techniques require proper orientation when the pointer contacts the display screen in order to avoid confusion with other pointer modalities.

It is therefore an object of the present invention at least to provide a novel interactive input system and a novel pen tool therefor.

### SUMMARY OF THE INVENTION

Accordingly, in one aspect there is provided a pen tool for use with an interactive input system comprising an elongate body, at least one switch assembly accommodated by said body, said at least one switch assembly being actuable when said pen tool is brought into contact with an input surface of said interactive input system and a controller accommodated by said body and communicating with said at least one switch assembly, said controller being responsive to actuation of said at least one switch assembly, wherein said at least one switch assembly comprises a contact circuit and a plunger assembly having a conductive element thereon that is generally aligned with said contact circuit, said plunger assembly being moveable into said body to bring said conductive element into contact with said contact circuit and thereby actuate said at least one switch assembly.

In one embodiment, the plunger assembly comprises a flexible cup element having a surface facing the contact surface and carrying the conductive element, and an elongate shaft fixed to the flexible cup element and extending beyond the body. The shaft moves into the body to cause the flexible cup element to flex and bring the conductive element and contact circuit into contact when the shaft is brought into contact with the input surface with a threshold activation force. The flexible cup may be formed of silicone and be disc-shaped. The plunger assembly may comprise a nib on a distal end of the shaft. The activation force is generally equal about 30 g and the shaft moves into the body a distance equal to about 0.1 mm in order to bring the conductive element into contact with the contact circuit.

In another embodiment, the contact circuit has a slim profile. In this case, the contact circuit comprises a contact circuit area generally aligned with the conductive element and a contact lead arranged generally at a right angle to the plane of the contact circuit. The contact lead is electrically coupled to the controller.

In another embodiment, the pen tool comprises at least two switch assemblies, with each switch assembly being associated with a different input and of the pen tool.

### BRIEF DESCRIPTION OF THE DRAWINGS

Embodiments will now be described more fully with reference to the accompanying drawings in which:

FIG. 1 is a perspective view of an interactive input system;

FIG. 2 is a block diagram view of the interactive input system of FIG. 1;

FIG. 3 is a block diagram of an imaging assembly forming part of the interactive input system of FIG. 1;

FIG. 4 is a front elevational view of a portion of a bezel segment forming part of the interactive input system of FIG. 1;

FIG. 5 is a block diagram of a digital signal processor forming part of the interactive input system of FIG. 1;

FIGS. 6a to 6c are image frames captured by the imaging assembly of FIG. 3;

FIGS. 7a to 7c show plots of normalized VIP_{dark}, VIPᵣₑₜᵣₒ and D(x) values calculated for the pixel columns of the image frames of FIGS. 6a to 6c;

FIG. 8 is a side elevational view of a pen tool used in conjunction with the interactive input system of FIG. 1;

FIG. 9 is partially exploded, side elevational view of the pen tool of FIG. 8;

FIG. 10 is a block diagram of the pen tool of FIG. 8;

FIG. 11 is an exploded perspective view of a tip assembly forming part of the pen tool of FIG. 8;

FIG. 12 is a cross-sectional view of the tip assembly of FIG. 11;

FIG. 13 is an exploded perspective view of a tip switch assembly forming part of the tip assembly of FIG. 12;

FIG. 14 is an exploded perspective view of an eraser assembly forming part of the pen tool of FIG. 8;

FIG. 15 is a side elevational view of an alternative pen tool for use in conjunction with the interactive input system of FIG. 1;

FIGS. 16a and 16b are side elevational views of yet another pen tool for use in conjunction with the interactive input system of FIG. 1;

FIGS. 17a and 17b are side elevational views of yet another pen tool for use in conjunction with the interactive input system of FIG. 1;

FIG. 18 is a side elevational view of still yet another pen tool for use in conjunction with the interactive input system of FIG. 1;

FIG. 19 shows a pop-up menu presented on a display surface of the interactive input system in response to interaction between a pen tool and the display surface; and

FIG. 20 shows a front elevational view of a portion of an alternative bezel segment.

### DETAILED DESCRIPTION OF THE EMBODIMENTS

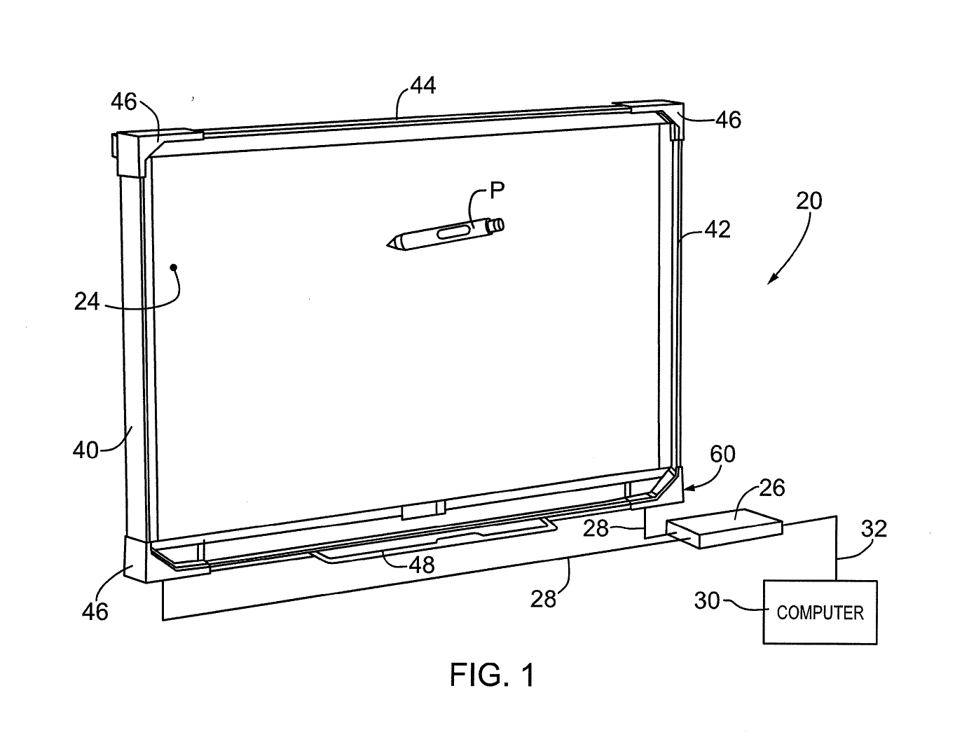

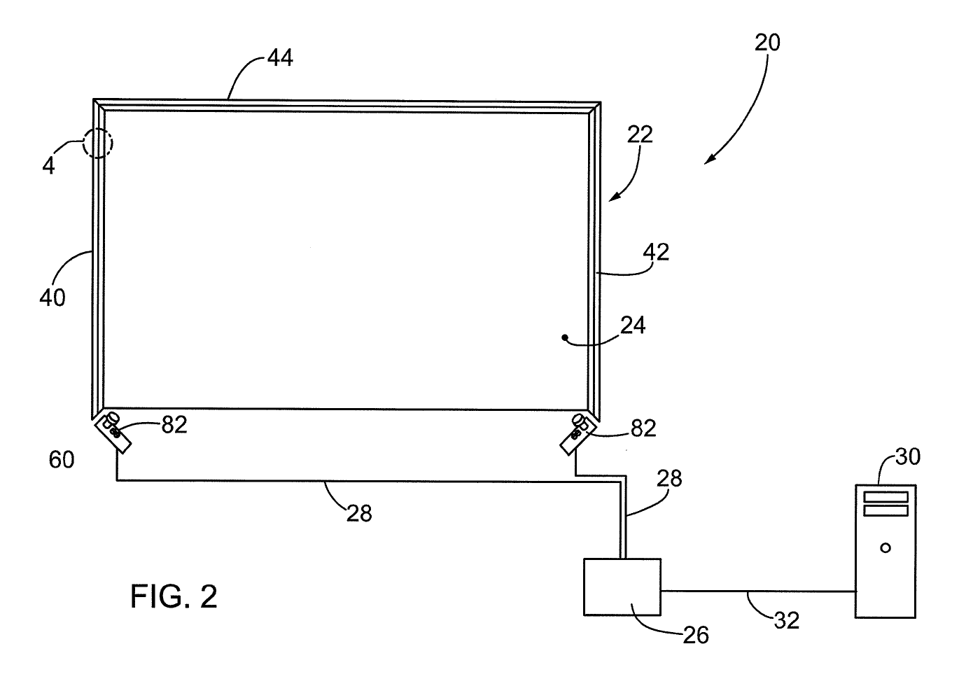

Turning now to FIGS. 1 and 2, an interactive input system that allows a user to input ink into an application program is shown and is generally identified by reference numeral 20. In this embodiment, interactive input system 20 comprises an assembly 22 that engages a display unit (not shown) such as for example, a plasma television, a liquid crystal display (LCD) device, a flat panel display device, a cathode ray tube etc. and surrounds the display surface 24 of the display unit. The assembly 22 employs machine vision to detect pointers brought into a region of interest in proximity with the display surface 24 and communicates with a digital signal processor (DSP) unit 26 via communication lines 28. The communication lines 28 may be embodied in a serial bus, a parallel bus, a universal serial bus (USB), an Ethernet connection or other suitable wired connection. The DSP unit 26 in turn communicates with a computer 30 executing one or more application programs via a USB cable 32. Alternatively, the DSP unit 26 may communicate with the computer 30 over another wired connection such as for example, a parallel bus, an RS-232 connection, an Ethernet connection etc. or may communicate with the computer 30 over a wireless connection using a suitable wireless protocol such as for example Bluetooth, WiFi, ZigBee, ANT, IEEE 802.15.4, Z-Wave etc. Computer 30 processes the output of the assembly 22 received via the DSP unit 26 and adjusts image data that is output to the display unit so that the image presented on the display surface 24 reflects pointer activity. In this manner, the assembly 22, DSP unit 26 and computer 30 form a closed loop allowing pointer activity proximate to the display surface 24 to be recorded as writing or drawing or used to control execution of one or more application programs executed by the computer 30.

Assembly 22 comprises a frame assembly that is mechanically attached to the display unit and surrounds the display surface 24. Frame assembly comprises a bezel having three bezel segments 40 to 44, four corner pieces 46 and a tool tray segment 48. Bezel segments 40 and 42 extend along opposite side edges of the display surface 24 while bezel segment 44 extends along the top edge of the display surface 24. The tool tray segment 48 extends along the bottom edge of the display surface 24 and supports one or more active pen tools P. The corner pieces 46 adjacent the top left and top right corners of the display surface 24 couple the bezel segments 40 and 42 to the bezel segment 44. The corner pieces 46 adjacent the bottom left and bottom right corners of the display surface 24 couple the bezel segments 40 and 42 to the tool tray segment 48. In this embodiment, the corner pieces 46 adjacent the bottom left and bottom right corners of the display surface 24 accommodate imaging assemblies 60 that look generally across the entire display surface 24 from different vantages. The bezel segments 40 to 44 are oriented so that their inwardly facing surfaces are seen by the imaging assemblies 60.

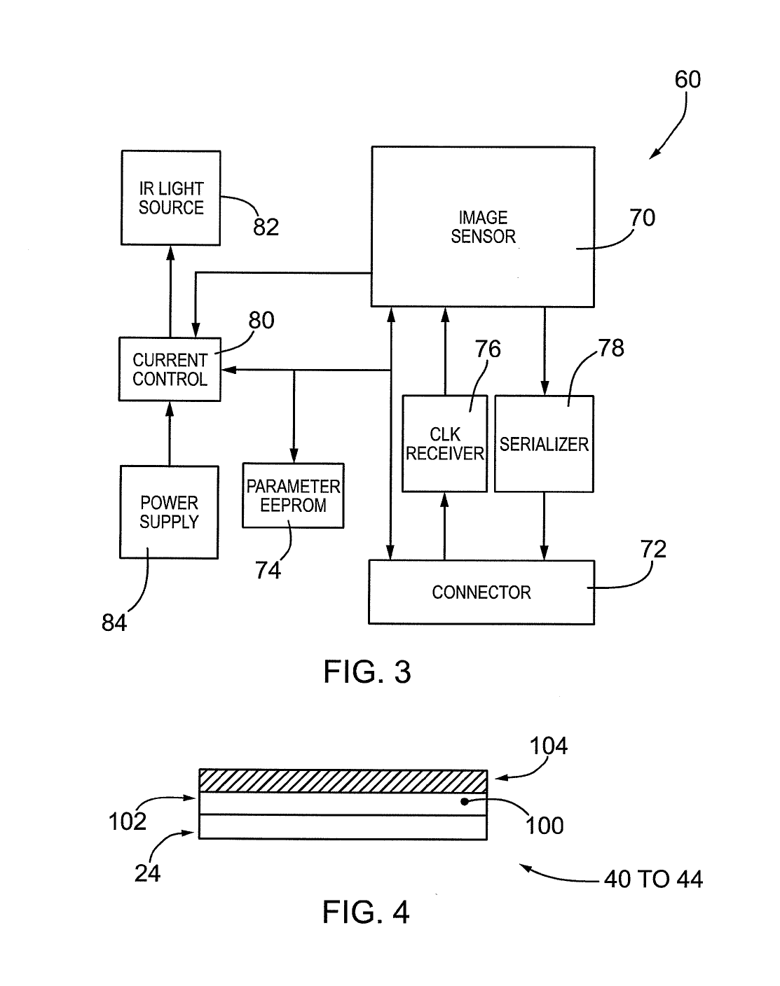

Turning now to FIG. 3, one of the imaging assemblies 60 is better illustrated. As can be seen, the imaging assembly 60 comprises an image sensor 70 such as that manufactured by Micron under model No. MT9V022 fitted with an 880 nm lens of the type manufactured by Boowon under model No. BW25B. The lens has an IR-pass/visible light blocking filter thereon (not shown) and provides the image sensor 70 with a 98 degree field of view so that the entire display surface 24 is seen by the image sensor 70. The image sensor 70 is connected to a connector 72 that receives one of the communication lines 28 via an I²C serial bus. The image sensor 70 is also connected to an electrically erasable programmable read only memory (EEPROM) 74 that stores image sensor calibration parameters as well as to a clock (CLK) receiver 76, a serializer 78 and a current control module 80. The clock receiver 76 and the serializer 78 are also connected to the connector 72. Current control module 80 is also connected to an infrared (IR) light source 82 comprising a plurality of IR light emitting diodes (LEDs) and associated lens assemblies as well as to a power supply 84 and the connector 72. Of course, those of skill in the art will appreciate that other types of suitable radiation sources to provide illumination to the region of interest may be used.

The clock receiver 76 and serializer 78 employ low voltage, differential signaling (LVDS) to enable high speed communications with the DSP unit 26 over inexpensive cabling. The clock receiver 76 receives timing information from the DSP unit 26 and provides clock signals to the image sensor 70 that determines the rate at which the image sensor 70 captures and outputs image frames. Each image frame output by the image sensor 70 is serialized by the serializer 78 and output to the DSP unit 26 via the connector 72 and communication lines 28.

FIG. 4 shows a portion of the inwardly facing surface 100 of one of the bezel segments 40 to 44. As can be seen, the inwardly facing surface 100 is divided into a plurality of generally horizontal strips or bands, each band of which has a different optical property. In this embodiment, the inwardly facing surface 100 of the bezel segment is divided into two (2) bands 102 and 104. The band 102 nearest the display surface 24 is formed of a retro-reflective material and the band 104 furthest from the display surface 24 is formed of an infrared (IR) radiation absorbing material. To take best advantage of the properties of the retro-reflective material, the bezel segments 40 to 44 are oriented so that their inwardly facing surfaces extend in a plane generally normal to that of the display surface 24.

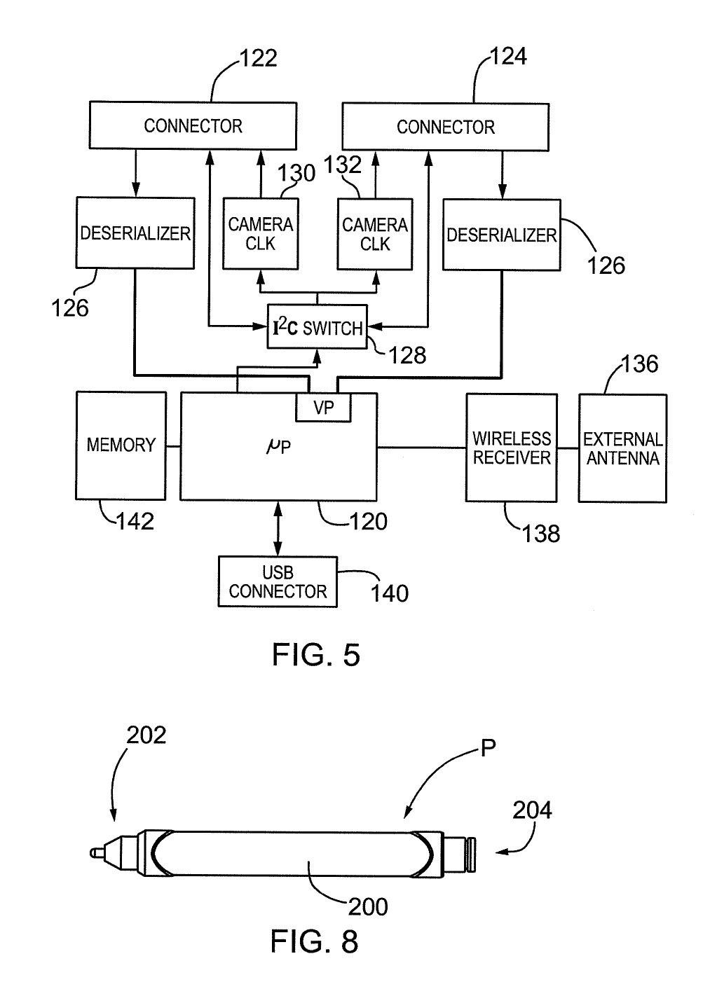

Turning now to FIG. 5, the DSP unit 26 is better illustrated. As can be seen, DSP unit 26 comprises a controller 120 such as for example, a microprocessor, microcontroller, DSP etc. having a video port VP connected to connectors 122 and 124 via deserializers 126. The controller 120 is also connected to each connector 122, 124 via an I²C serial bus switch 128. I²C serial bus switch 128 is connected to clocks 130 and 132, each clock of which is connected to a respective one of the connectors 122, 124. The controller 120 communicates with an external antenna 136 via a wireless receiver 138, a USB connector 140 that receives USB cable 32 and memory 142 including volatile and non-volatile memory. The clocks 130 and 132 and deserializers 126 similarly employ low voltage, differential signaling (LVDS).

The interactive input system 20 is able to detect passive pointers such as for example, a user's finger, a cylinder or other suitable object as well as active pen tools P that are brought into proximity with the display surface 24 and within the fields of view of the imaging assemblies 60. For ease of discussion, the operation of the interactive input system 20, when a passive pointer is brought into proximity with the display surface 24, will firstly be described.

During operation, the controller 120 conditions the clocks 130 and 132 to output clock signals that are conveyed to the imaging assemblies 60 via the communication lines 28. The clock receiver 76 of each imaging assembly 60 uses the clock signals to set the frame rate of the associated image sensor 70. In this embodiment, the controller 120 generates clock signals so that the frame rate of each image sensor 70 is twice the desired image frame output rate. The controller 120 also signals the current control module 80 of each imaging assembly 60 over the I²C serial bus. In response, each current control module 80 connects the IR light source 82 to the power supply 84 and then disconnects the IR light source 82 from the power supply 84 so that each IR light source 82 turns on and off. The timing of the on/off IR light source switching is controlled so that for each pair of subsequent image frames captured by each image sensor 70, one image frame is captured when the IR light source 82 is on and one image frame is captured when the IR light source 82 is off.

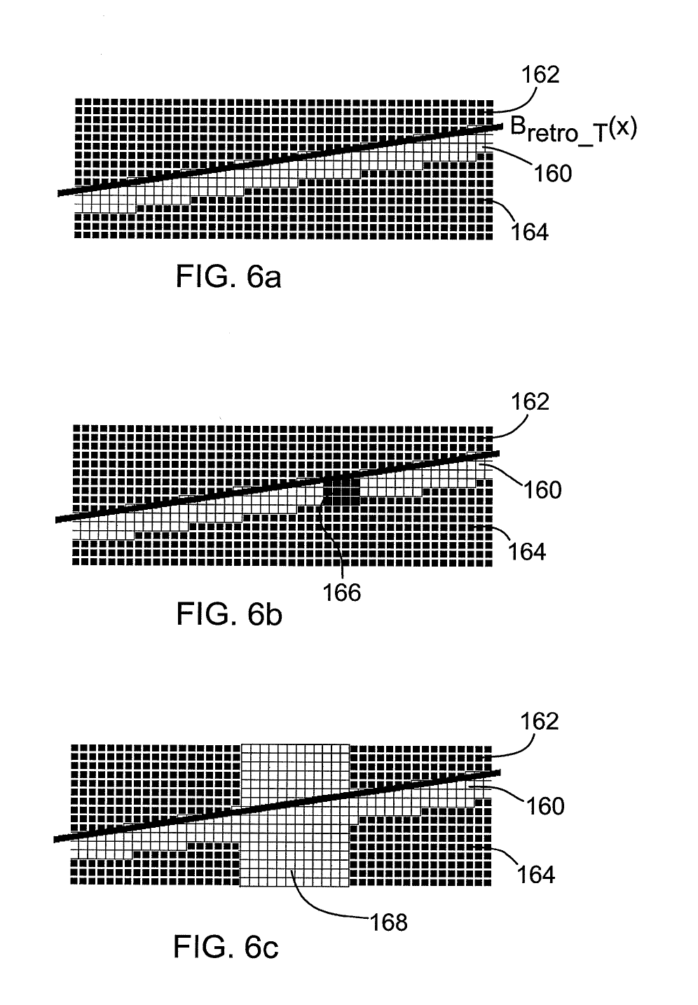

When the IR light sources 82 are on, the LEDs of the IR light sources flood the region of interest over the display surface 24 with infrared illumination. Infrared illumination that impinges on the IR radiation absorbing bands 104 of the bezel segments 40 to 44 is not returned to the imaging assemblies 60. Infrared illumination that impinges on the retro-reflective bands 102 of the bezel segments 40 to 44 is returned to the imaging assemblies 60. The configuration of the LEDs of each IR light source 82 is selected so that the retro-reflective bands 102 are generally evenly illuminated over their entire lengths. Further specifics concerning the IR light sources 82 are described in U.S. patent application Ser. No. ______ to Hansen et al. entitled “Interactive Input System And Illumination Assembly Therefor” filed concurrently herewith and assigned to SMART Technologies ULC of Calgary, Alberta, the content of which is incorporated herein by reference. As a result, in the absence of a pointer, the image sensor 70 of each imaging assembly 60 sees a bright band 160 having a substantially even intensity over its length disposed between an upper dark band 162 corresponding to the IR radiation absorbing bands 104 and a lower dark band 164 corresponding to the display surface 24 as shown in FIG. 6a. When a pointer is brought into proximity with the display surface 24 and is sufficiently distant from the IR light sources 82, the pointer occludes infrared illumination reflected by the retro-reflective bands 102. As a result, the pointer appears as a dark region 166 that interrupts the bright band 160 in captured image frames as shown in FIG. 6b.

As mentioned above, each image frame output by the image sensor 70 of each imaging assembly 60 is conveyed to the DSP unit 26. When the DSP unit 26 receives image frames from the imaging assemblies 60, the controller 120 processes the image frames to detect the existence of a pointer therein and if a pointer exists, to determine the position of the pointer relative to the display surface 24 using triangulation. To reduce the effects unwanted light may have on pointer discrimination, the controller 120 measures the discontinuity of light within the image frames rather than the intensity of light within the image frames to detect the existence of a pointer. There are generally three sources of unwanted light, namely ambient light, light from the display unit and infrared illumination that is emitted by the IR light sources 82 and scattered off of objects proximate to the imaging assemblies 60. As will be appreciated, if a pointer is close to an imaging assembly 60, infrared illumination emitted by the associated IR light source 82 may illuminate the pointer directly resulting in the pointer being as bright as or brighter than the retro-reflective bands 102 in captured image frames. As a result, the pointer will not appear in the image frames as a dark region interrupting the bright band 160 but rather will appear as a bright region 168 that extends across the bright band 160 and the upper and lower dark bands 162 and 164 as shown in FIG. 6c.

The controller 120 processes successive image frames output by the image sensor 70 of each imaging assembly 60 in pairs. In particular, when one image frame is received, the controller 120 stores the image frame in a buffer. When the successive image frame is received, the controller 120 similarly stores the image frame in a buffer. With the successive image frames available, the controller 120 subtracts the two image frames to form a difference image frame. Provided the frame rates of the image sensors 70 are high enough, ambient light levels in successive image frames will typically not change significantly and as a result, ambient light is substantially cancelled out and does not appear in the difference image frame.

Once the difference image frame has been generated, the controller 120 processes the difference image frame and generates discontinuity values that represent the likelihood that a pointer exists in the difference image frame. When no pointer is in proximity with the display surface 24, the discontinuity values are high. When a pointer is in proximity with the display surface 24, some of the discontinuity values fall below a threshold value allowing the existence of the pointer in the difference image frame to be readily determined.

In order to generate the discontinuity values for each difference image frame, the controller 120 calculates a vertical intensity profile (VIPᵣₑₜᵣₒ) for each pixel column of the difference image frame between bezel lines Bᵣₑₜᵣₒ_{_{—}}_{T}(x) and Bᵣₑₜᵣₒ_{_{—}}_{B}(x) that generally represent the top and bottom edges of the bright band 160 in the difference image and calculates a VIP_{dark} for each pixel column of the difference image frame between bezel lines B_{dark}_{_{—}}_{T}(x) and B_{dark}_{_{—}}_{B}(x) that generally represent the top and bottom edges of the upper dark band 162 in the difference image. The bezel lines are determined via a bezel finding procedure performed during calibration at interactive input system start up, as will be described.

The VIPᵣₑₜᵣₒ for each pixel column is calculated by summing the intensity values I of N pixels in that pixel column between the bezel lines Bᵣₑₜᵣₒ_{_{—}}_{T}(x) and Bᵣₑₜᵣₒ_{_{—}}_{B}(x). The value of N is determined to be the number of pixel rows between the bezel lines Bᵣₑₜᵣₒ_{_{—}}_{T}(x) and Bᵣₑₜᵣₒ_{_{—}}_{B}(x), which is equal to the width of the retro-reflective bands 102. If any of the bezel lines falls partway across a pixel of the difference image frame, then the intensity level contribution from that pixel is weighted proportionally to the amount of the pixel that falls inside the bezel lines Bᵣₑₜᵣₒ_{_{—}}_{T}(x) and Bᵣₑₜᵣₒ_{_{—}}_{B}(x). During VIPᵣₑₜᵣₒ calculation for each pixel column, the location of the bezel lines Bᵣₑₜᵣₒ_{_{—}}_{T}(x) and Bᵣₑₜᵣₒ_{_{—}}_{B}(x) within that pixel column are broken down into integer components Bᵢ_{_{—}}ᵣₑₜᵣₒ_{_{—}}_{T}(x), Bᵢ_{_{—}}ᵣₑₜᵣₒ_{_{—}}_{B}(x), and fractional components B_{f}_{_{—}}ᵣₑₜᵣₒ_{_{—}}_{T}(x) retro Bᵢ_{_{—}}ᵣₑₜᵣₒ_{_{—}}_{B}(x) represented by:

Bᵢ_{_{—}}ᵣₑₜᵣₒ_{_{—}}_{T}(x)=ceil[Bᵣₑₜᵣₒ_{_{—}}_{T}(x)]

Bᵢ_{_{—}}ᵣₑₜᵣₒ_{_{—}}_{B}(x)=floor[Bᵣₑₜᵣₒ_{_{—}}_{B}(x)]

B_{f}_{_{—}}ᵣₑₜᵣₒ_{_{—}}_{T}(x)=Bᵢ_{_{—}}ᵣₑₜᵣₒ_{_{—}}_{T}(x)−Bᵣₑₜᵣₒ_{_{—}}_{T}(x)

B_{f}_{_{—}}ᵣₑₜᵣₒ_{_{—}}_{B}(x)=Bᵣₑₜᵣₒ_{_{—}}_{B}(x,y)−Bᵢ_{_{—}}ᵣₑₜᵣₒ_{_{—}}_{B}(x)

The VIPᵣₑₜᵣₒ for the pixel column is then calculated by summing the intensity values I of the N pixels along the pixel column that are between the bezel lines Bᵣₑₜᵣₒ_{_{—}}_{T}(x) and Bᵣₑₜᵣₒ_{_{—}}_{B}(x) with the appropriate weighting at the edges according to:

VIPᵣₑₜᵣₒ(x)=(B_{f}_{_{—}}ᵣₑₜᵣₒ_{_{—}}_{T}(x)I(x,Bᵢ_{_{—}}ᵣₑₜᵣₒ_{_{—}}_{T}(x)−1)+(B_{f}_{_{—}}ᵣₑₜᵣₒ_{_{—}}_{B}(x)I(x,Bᵢ_{_{—}}ᵣₑₜᵣₒ_{_{—}}_{B}(x))+sum(I(x,Bᵢ_{_{—}}ᵣₑₜᵣₒ_{_{—}}_{T}+j)

where N=(Bᵢ_{_{—}}ᵣₑₜᵣₒ_{_{—}}_{B}(x)−Bᵢ_{_{—}}ᵣₑₜᵣₒ_{_{—}}_{T}(x)), j is in the range of 0 to N and I is the intensity at location x between the bezel lines.

The VIP_{dark} for each pixel column is calculated by summing the intensity values I of K pixels in that pixel column between the bezel lines B_{dark}_{_{—}}_{T}(x) and B_{dark}_{_{—}}_{B}(x). The value of K is determined to be the number of pixel rows between the bezel lines B_{dark}_{_{—}}_{T}(x) and B_{dark}_{_{—}}_{B}(x), which is equal to the width of the IR radiation absorbing bands 104. If any of the bezel lines falls partway across a pixel of the difference image frame, then the intensity level contribution from that pixel is weighted proportionally to the amount of the pixel that falls inside the bezel lines B_{dark}_{_{—}}_{T}(x) and B_{dark}_{_{—}}_{B}(x). During VIP_{dark} calculation for each pixel column, the location of the bezel lines B_{dark}_{_{—}}_{T}(x) and B_{dark}_{_{—}}_{B}(x) within that pixel column are broken down into integer components Bᵢ_{_{—}}_{dark}_{_{—}}_{T}(x), Bᵢ_{_{—}}_{dark}_{_{—}}_{B}(x), and fractional components B_{f}_{_{—}}_{dark}_{_{—}}_{T}(x) and Bᵢ_{_{—}}_{dark}_{_{—}}_{B}(x) represented by:

Bᵢ_{_{—}}_{dark}_{_{—}}_{T}(x)=ceil[B_{dark}_{_{—}}_{T}(x)]

Bᵢ_{_{—}}_{dark}_{_{—}}_{B}(x)=floor[B_{dark}_{_{—}}_{B}(x)]

B_{f}_{_{—}}_{dark}_{_{—}}_{T}(x)=Bᵢ_{_{—}}_{dark}_{_{—}}_{T}(x)−B_{dark}_{_{—}}_{T}(x)

B_{f}_{_{—}}_{dark}_{_{—}}_{B}(x)=B_{dark}_{_{—}}_{B}(x,y)−Bᵢ_{_{—}}_{dark}_{_{—}}_{B}(x)

The VIP_{dark} for each pixel column is calculated in a similar manner by summing the intensity values I of the K pixels along the pixel column that are between the bezel lines B_{dark}_{_{—}}_{T}(x) and B_{dark}_{_{—}}_{B}(x) with the appropriate weighting at the edges according to:

VIP_{dark}(x)=(B_{f}_{_{—}}_{dark}_{_{—}}_{T}(x)I(x,Bᵢ_{_{—}}_{dark}_{_{—}}_{T}(x)−1)+(B_{f}_{_{—}}_{dark}_{_{—}}_{B}(x)I(x,Bᵢ_{_{—}}_{dark}_{_{—}}_{B}(x))+sum(I(x,Bᵢ_{_{—}}_{dark}_{_{—}}_{T}+j)

where K=(Bᵢ_{_{—}}_{dark}_{_{—}}_{B}(x)−Bᵢ_{_{—}}_{dark}_{_{—}}_{T}(x)) and j is in the range of 0 to N.

The VIPs are subsequently normalized by dividing them by the corresponding number of pixel rows (N for the retro-reflective regions, and K for the dark regions). The discontinuity value D(x) for each pixel column is then calculated by determining the difference between VIPᵣₑₜᵣₒ and VIP_{dark} according to:

D(x)=VIPᵣₑₜᵣₒ(x)−VIP_{dark}(x)

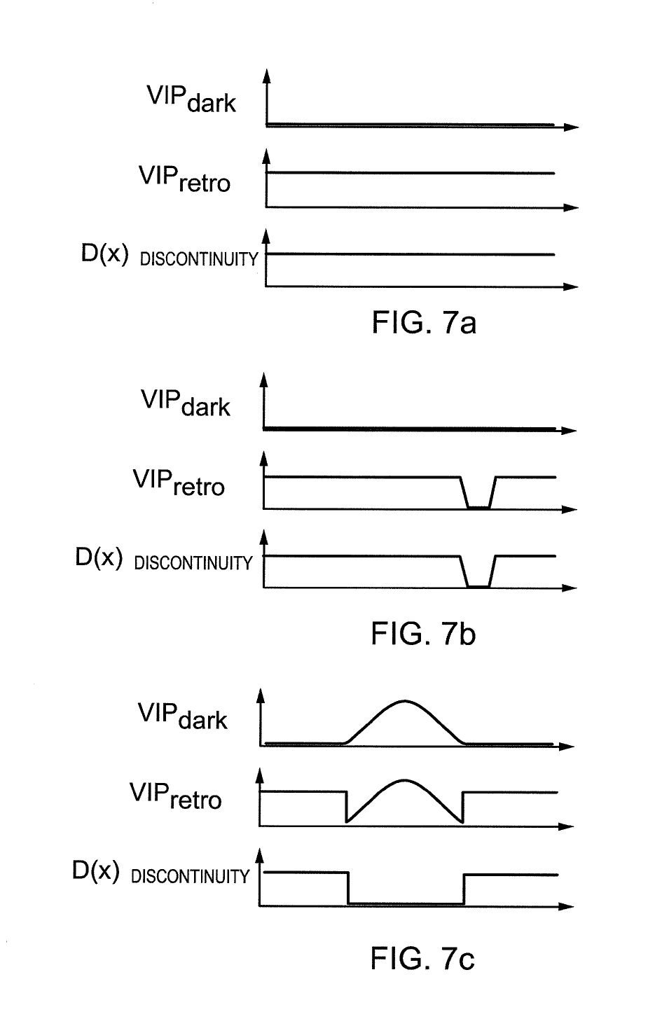

FIG. 7a shows plots of the normalized VIP_{dark}, VIPᵣₑₜᵣₒ and D(x) values calculated for the pixel columns of the image frame of FIG. 6a. As will be appreciated, in this image frame no pointer exists and thus, the discontinuity values D(x) remain high for all of the pixel columns of the image frame. FIG. 7b shows plots of the normalized VIP_{dark}, VIPᵣₑₜᵣₒ and D(x) values calculated for the pixel columns of the image frame of FIG. 6b. As can be seen, the D(x) curve drops to low values at a region corresponding to the location of the pointer in the image frame. FIG. 7c shows plots of the normalized VIP_{dark}, VIPᵣₑₜᵣₒ and D(x) values calculated for the pixel columns of the image frame of FIG. 6c. As can be seen, the D(x) curve also drops to low values at a region corresponding to the location of the pointer in the image frame.

Once the discontinuity values D(x) for the pixel columns of each difference image frame have been determined, the resultant D(x) curve for each difference image frame is examined to determine if the D(x) curve falls below a threshold value signifying the existence of a pointer and if so, to detect left and right edges in the D(x) curve that represent opposite sides of a pointer. In particular, in order to locate left and right edges in each difference image frame, the first derivative of the D(x) curve is computed to form a gradient curve ∇D(x). If the D(x) curve drops below the threshold value signifying the existence of a pointer, the resultant gradient curve ∇D(x) will include a region bounded by a negative peak and a positive peak representing the edges formed by the dip in the D(x) curve. In order to detect the peaks and hence the boundaries of the region, the gradient curve ∇D(x) is subjected to an edge detector.

In particular, a threshold T is first applied to the gradient curve ∇D(x) so that, for each position x, if the absolute value of the gradient curve ∇D(x) is less than the threshold, that value of the gradient curve ∇D(x) is set to zero as expressed by:

∇D(x)=0, if |∇D(x)|<T

Following the thresholding procedure, the thresholded gradient curve ∇D(x) contains a negative spike and a positive spike corresponding to the left edge and the right edge representing the opposite sides of the pointer, and is zero elsewhere. The left and right edges, respectively, are then detected from the two non-zero spikes of the thresholded gradient curve ∇D(x). To calculate the left edge, the centroid distance CD_{left} is calculated from the left spike of the thresholded gradient curve ∇D(x) starting from the pixel column X_{left} according to:

$${CD}_{left} = \frac{{\sum }_{i} ( {x}_{i} - {X}_{left} ) ▽ D ( {x}_{i} )}{{\sum }_{i} ▽ D ( {x}_{i} )}$$

where xᵢ is the pixel column number of the i-th pixel column in the left spike of the gradient curve ∇D(x), i is iterated from 1 to the width of the left spike of the thresholded gradient curve ∇D(x) and X_{left} is the pixel column associated with a value along the gradient curve ∇D(x) whose value differs from zero (0) by a threshold value determined empirically based on system noise. The left edge in the thresholded gradient curve ∇D(x) is then determined to be equal to X_{left}+CD_{left}.

To calculate the right edge, the centroid distance CD_{right} is calculated from the right spike of the thresholded gradient curve ∇D(x) starting from the pixel column X_{right} according to:

$${CD}_{right} = \frac{{\sum }_{j} ( {x}_{i} - {X}_{right} ) ▽ D ( {x}_{j} )}{{\sum }_{j} ▽ D ( {x}_{j} )}$$

where xⱼ is the pixel column number of the j-th pixel column in the right spike of the thresholded gradient curve ∇D(x), j is iterated from 1 to the width of the right spike of the thresholded gradient curve ∇D(x) and X_{right} is the pixel column associated with a value along the gradient curve ∇D(x) whose value differs from zero (0) by a threshold value determined empirically based on system noise. The right edge in the thresholded gradient curve is then determined to be equal to X_{right}+CD_{right}.

Once the left and right edges of the thresholded gradient curve ∇D(x) are calculated, the midpoint between the identified left and right edges is then calculated thereby to determine the location of the pointer in the difference image frame.

After the location of the pointer in each difference frame has been determined, the controller 120 uses the pointer positions in the difference image frames to calculate the position of the pointer in (x,y) coordinates relative to the display surface 24 using triangulation in a manner similar to that described in above incorporated U.S. Pat. No. 6,803,906 to Morrison et al. The calculated pointer coordinate is then conveyed by the controller 120 to the computer 30 via the USB cable 32. The computer 30 in turn processes the received pointer coordinate and updates the image output provided to the display unit, if required, so that the image presented on the display surface 24 reflects the pointer activity. In this manner, pointer interaction with the display surface 24 can be recorded as writing or drawing or used to control execution of one or more application programs running on the computer 30.

During the bezel finding procedure performed at interactive input system start up, a calibration procedure is performed for each image sensor to determine the bezel lines Bᵣₑₜᵣₒ_{_{—}}_{T}(x), Bᵣₑₜᵣₒ_{_{—}}_{B}(x), B_{dark}_{_{—}}_{T}(x) and B_{dark}_{_{—}}_{B}(x). During each calibration procedure, a calibration image pair is captured by the associated image sensor 70. One calibration image of the pair is captured while the IR light source 82 associated with the image sensor is on and the other calibration image of the pair is captured while the IR light source 82 associated with the image sensor is off. The two calibration images are then subtracted to form a calibration difference image thereby to remove ambient lighting artifacts. The pixel rows of interest of the calibration difference image (i.e. the pixel rows forming the bright band 160 representing the retro-reflective bands 102) are then determined.

During this process, the sum of pixel values for each pixel row of the calibration difference image is calculated to generate a horizontal intensity profile for the calibration difference image. A gradient filter is then applied to the horizontal intensity profile. The gradient filter takes the absolute value of the second derivative of the horizontal intensity profile and applies a sixteen (16) point Gaussian filter to smooth the result. Each region of data having values greater than fifty percent (50%) of the peak value is then examined to detect the region having the largest area. The midpoint of that region is then designated as the center pixel row. The first and last eighty (80) pixel rows of the horizontal intensity profile are not used during this process to reduce the impact of lighting artifacts and external infrared light sources.

Each pixel column of the calibration difference image is then processed to determine the pixels therein corresponding to the bright band 160. Initially, the locations of the image sensors 70 are not known and so an arbitrary processing direction is selected. In this embodiment, the pixel columns of the calibration difference image are processed from left to right. During processing of each pixel column, a small slice of the pixel data for the pixel column is taken based on the location of the center pixel row. In this embodiment, the slice comprises one hundred pixel rows centered on the center pixel row. Each image slice is cross-correlated with a Gaussian model used to approximate the retro-reflective bands 102 in intensity and width. The results of the cross-correlation identify the bright band 160 of the calibration difference image that represents the retro-reflective bands 102 of the bezel. This correlation is multiplied with the calibration image that was captured with the IR light source 82 on to highlight further the bright band 160 and reduce noise.

Afterwards, for each pixel column, a peak-search algorithm is then applied to the resulting pixel column data to locate peaks. If one peak is found, it is assumed that no differentiation between the retro-reflective bands 102 of the bezel and its reflection in the display surface 24 is possible in the pixel column. If two peaks are found, it is assumed that the retro-reflective bands of the bezel and their reflections in the display surface 24 are visible in the pixel column and can be differentiated. For each pixel column where two peaks are found, the width of the bright band 160 representing the retro-reflection bands and the band representing the reflection of the retro-reflective bands 102 in the display surface 24 are determined by finding the rising and falling edges surrounding the detected peaks. With the width of the bright band 160 in the pixel columns known, the bezel lines Bᵣₑₜᵣₒ_{_{—}}_{T}(x) and Bᵣₑₜᵣₒ_{_{—}}_{B}(x) can be estimated. From the width of the bright band 160, the upper dark band 162 is determined to be directly above the bright band 160 and to have a width general equal to that of the bright band. As bezel line B_{dark}_{_{—}}_{B}(x) is coincident with bezel line Bᵣₑₜᵣₒ_{_{—}}_{T}(x), the bezel line B_{dark}_{_{—}}_{T}(x) can also be estimated.

The start and end pixel columns of the bezel are then determined by looking at the intensity of the pixel column data for the first one hundred and fifty (150) and last first one hundred and fifty (150) pixel columns. The inner-most pixel column in the first one-hundred and fifty pixel columns that has a value lower than a threshold value is determined to be the start of the bezel and the inner-most pixel column in the last one-hundred and fifty pixel columns that has a value lower than the threshold value is determined to be the end of the bezel.

After the start and end points of the bezel have been found, a continuity check is performed to confirm that the pixels of the bright band 160 are close to each other from pixel column to pixel column. During this check, the pixels of the bright band 160 in adjacent pixel columns are compared to determine if the distance therebetween is beyond a threshold distance signifying a spike. For each detected spike, pixels of the bright band 160 on opposite sides of the spike region are interpolated and the interpolated values are used to replace the pixels of the spike. This process patches gaps in the bright band 160 caused by image sensor overexposure or bezel occlusion as well as to smooth out any misidentified bezel points.

The width of the bright band 160 at the left side and the right side of the resulting image is then examined. The side of the resulting image associated with the smallest bright band width is deemed to represent the portion of the bezel that is furthest from the image sensor 70. The procedure to determine the pixels of the bright band in each pixel column and continuity check discussed above are then re-performed. During this second pass, the direction the image data is processed is based on the location of the image sensor 70 relative to the bezel. The image data representing the portion of the bezel that is closest to the image sensor 70 is processed first. As a result, during the second pass, the pixel columns of the resulting image are processed from left to right for the image sensor 70 at the bottom left corner of the display surface 24 and from right to left for the image sensor 70 at the bottom right corner of the display surface 24 in the manner described above. During this second pass, the peak-search algorithm focuses around the pixel column data corresponding to the estimated bezel lines Bᵣₑₜᵣₒ_{_{—}}_{T}(x) and Bᵣₑₜᵣₒ_{_{—}}_{B}(x).

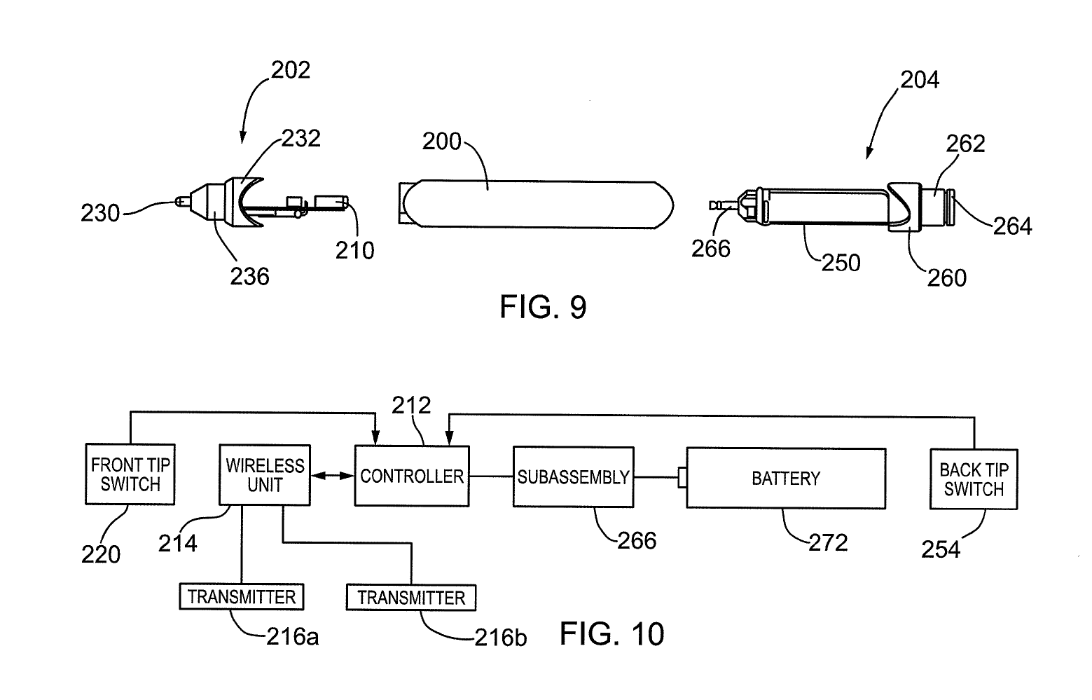

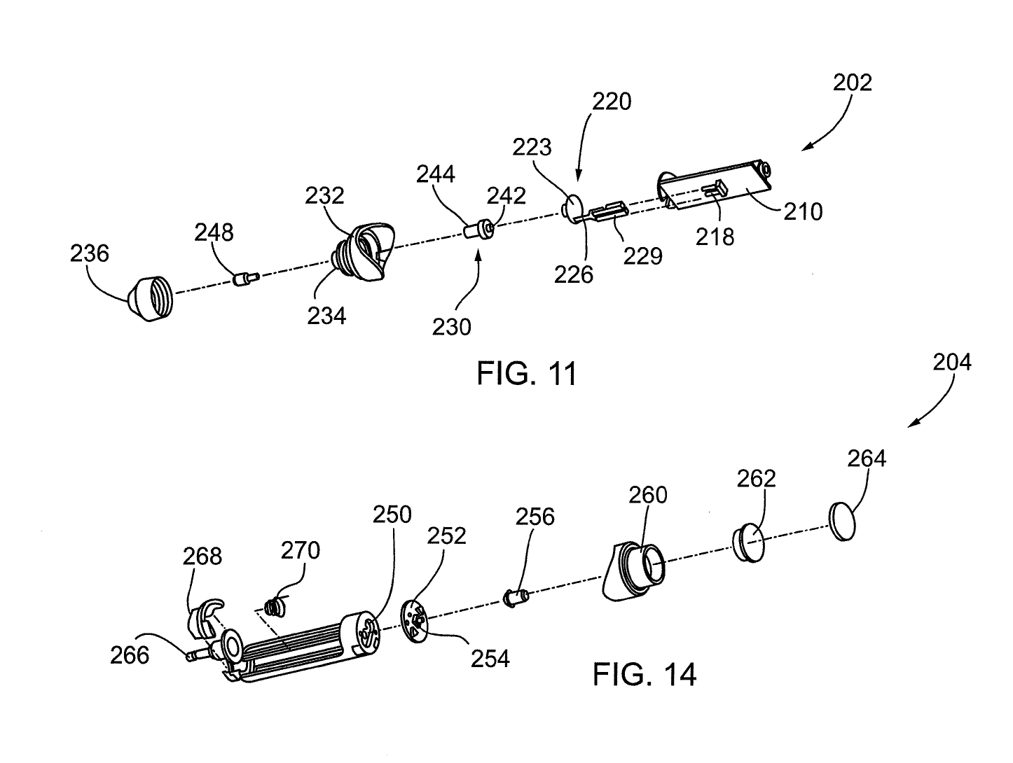

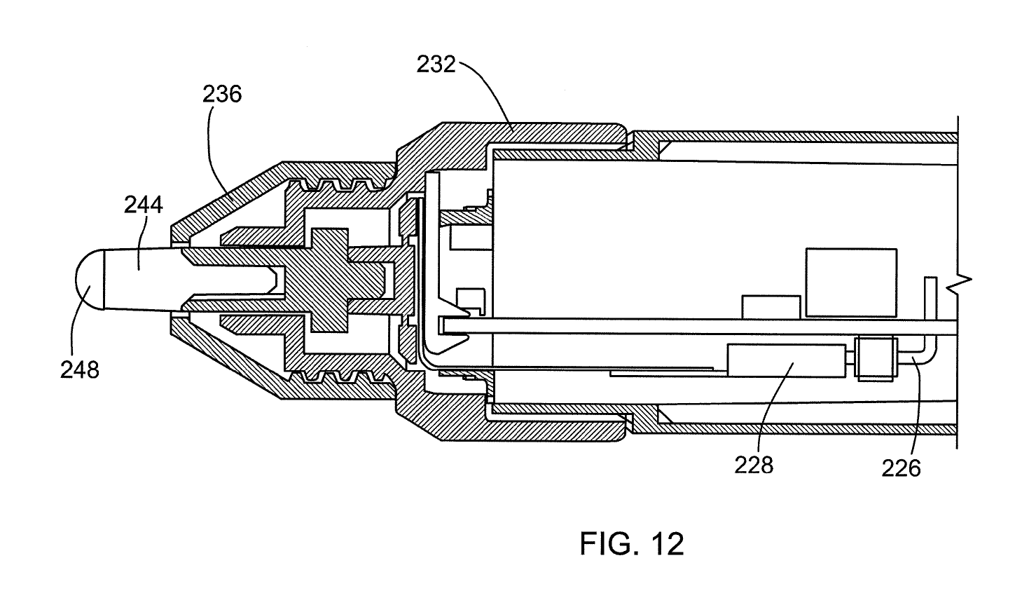

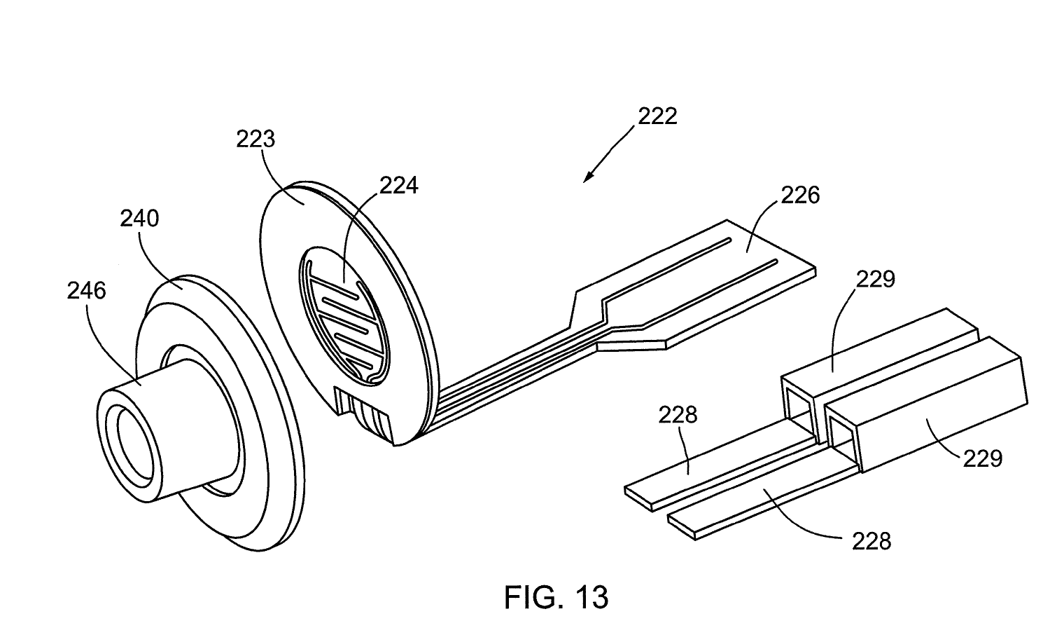

Turning now to FIGS. 8 to 14, one of the pen tools P for use in conjunction with the interactive input system 20 is shown and is generally identified by reference numeral 200. As can be seen, the pen tool P comprises a hollow body 200 formed by interconnected half shells that accommodates a tip assembly 202 at one end and an eraser assembly 204 at its other end. The tip assembly 202 comprises a printed circuit board 210 on which a controller 212 is mounted. The controller 212 communicates with a wireless unit 214 that broadcasts signals via wireless transmitters 216a and 216b such as for example, radio frequency (RF) antennae or IR LEDs. Tip switch contacts 218 are also mounted on the printed circuit board 210. A tip switch assembly 220 is mounted on the printed circuit board 210.

The tip switch assembly 220 comprises a polyester flex circuit 222 having a circular portion 223 that accommodates a contact circuit area 224. A contact lead 226 extends from the contact circuit area 224 and undergoes a ninety-degree turn relative to the plane of the circular portion 223. Leads 228 are attached to the contact lead 226 and terminate at crimp connectors 229. The crimp connectors 229 receive the tip switch contacts 218 thereby to connect electrically the tip switch assembly 220 to the controller 212. A plunger assembly 230 is aligned with the flex circuit 222. The plunger assembly 230 passes through a cap 232 that fits over the end of the body 200. The cap 232 has an externally threaded nose 234 that receives an internally threaded cone 236. The plunger assembly 230 extends through a hole in the cone 236 to define a writing tip for the pen tool P.

The plunger assembly 230 comprises a flexible cup 240 formed of silicone. The surface of the cup 240 that faces the flex circuit 222 has a conductive pad thereon 242. The conductive pad 242 is aligned with the contact circuit area 224. A generally cylindrical shaft 244 is received by a cylindrical tube 246 extending from the cup 240. The distal end of the shaft 244 has a nib 248 formed thereon.

The eraser assembly 204 comprises a battery carrier 250 having positive and negative leads. A printed circuit board 252 carrying a switch 254 that is electrically connected to the controller 212 is secured to one end of the battery carrier 250. A plunger 256 is aligned with the switch 254 and passes through a holder 260 that surrounds the printed circuit board 252 and one end of the battery carrier 250 and that fits over the end of the body 200. A cap 262 having a felt-like pad 264 thereon is received by the holder 260. A commercially available electrical subassembly 266 extends from the other end of the battery carrier 250 to the printed circuit board 210 and is retained by a half shell 268 that engages the end of the battery carrier 250. A spring 270 is accommodated by the battery carrier 250 to retain a battery 272 placed therein. The electrical subassembly 266 connects the battery 272 to the printed circuit boards 252 and 210 and provides a communication channel between the printed circuit boards.

When the pen tool P is brought into proximity with the display surface 24, its location relative to the display surface in (x,y) coordinates is calculated in the same manner as described above with reference to the passive pointer. However, depending on the manner in which the pen tool P is brought into contact with the display surface 24, the pen tool P may provide mode information that is used to interpret pen tool activity relative to the display surface 24. In particular, when the nib 248 of the pen tool P is brought into contact with the display surface 24 with sufficient force, the shaft 244 of the plunger assembly 230 moves inwardly into the body 200. This inward movement of the shaft 244 causes the cup 240 to flex thereby bringing the conductive pad 242 on the cup into contact the contact circuit area 224 of the flex circuit 222 resulting in closing of the tip switch assembly 220. Closing of the tip switch assembly 220 is sensed by the controller 212 and causes the controller 212 to condition the wireless unit 214 to output a modulated signal that is broadcast via the wireless transmitter 216a. The wireless transmitter 216a is positioned so that the modulated signal is emitter from the pen tool P slight aft of its tip.

The design of the plunger assembly 230 provides advantages in that a low activation force is required to move the shaft 244 of the plunger assembly 230 to close the tip switch assembly 220. Also, the shaft 244 of the plunger assembly 230 is not required to travel significantly into the body 200 to close the tip switch assembly 220. In particular, only about a 30 g activation force and a shaft travel equal to approximately 0.1 mm is required in order for the tip switch assembly 220 to close. The factors give the pen tool P a much more compliant writing feel with significantly less noise as compared to prior art pen tools. Also, the configuration of the flex circuit 222 gives the tip switch assembly 220 a slim profile so that the tip switch assembly has no appreciable impact on the diameter of the pen tool P.

When the cap 262 of the pen tool P is brought into contact with the display surface 24 with sufficient force, the cap 262 moves into the holder 260 thereby causing the plunger 256 to close the switch 254. Closing of the switch 254 is sensed by the controller 212 resulting in the controller 212 conditioning the wireless unit 214 to output a differently modulated signal that is broadcast via the wireless transmitter 216b. Similarly, the wireless transmitter 216b is positioned so that the modulated signal is emitter from the pen tool P slight aft of its eraser end.

The DSP unit 26 stores a modulated signal-to-pen tool mode mapping table in the memory 142. As a result, when a broadcast modulated signal is received by the controller 120 of the DSP unit 26 via the antenna 136, the controller 120 compares the received modulated signal to the mapping table to determine the pen tool mode. The controller 120 in turn uses this information to assign mode information to the generated pointer coordinates and conveys the mode information along with the pointer coordinates to the computer 30 so that the pointer coordinates are processed by the computer 30 in the desired manner. In this embodiment, when the nib 248 is in contact with the display surface 24 and the tip switch assembly 220 is closed, the pen tool P is deemed to be operating in an ink mode. Ink mode information is assigned to pointer coordinates generated by the controller 120 while the pen tool P is in this mode so that the computer 30 treats the pointer coordinates as writing or drawing (i.e. ink) on the display surface 24. When the cap 262 is in contact with the display surface 24 and the switch 254 is closed, the pen tool P is deemed to be operating in an eraser mode. Eraser mode information is assigned to pointer coordinates generated by the controller 120 while the pen tool is in this mode so that the computer 30 erases displayed ink at locations corresponding to the pointer coordinates. When no modulated signal is output by the pen tool P, the pen tool is deemed to be operating in a pointer mode and is treated in the same manner as a passive pointer. Pointer mode information is assigned to pointer coordinates generated by the controller 120 while the pen tool is in this mode so that the computer 30 treats the pointer coordinates as mouse events.

If desired, the IR light sources 82 can be modulated as described in U.S. patent application Ser. No. ______ to McReynolds et al. entitled “Interactive Input System with Controlled Lighting” filed concurrently herewith and assigned to SMART Technologies ULC of Calgary, Alberta, the content of which is incorporated by reference. In this manner, image frames for each imaging assembly based only on the contribution of illumination from its associated IR light source can be generated. The modulated signals output by the pen tool P can also be modulated.

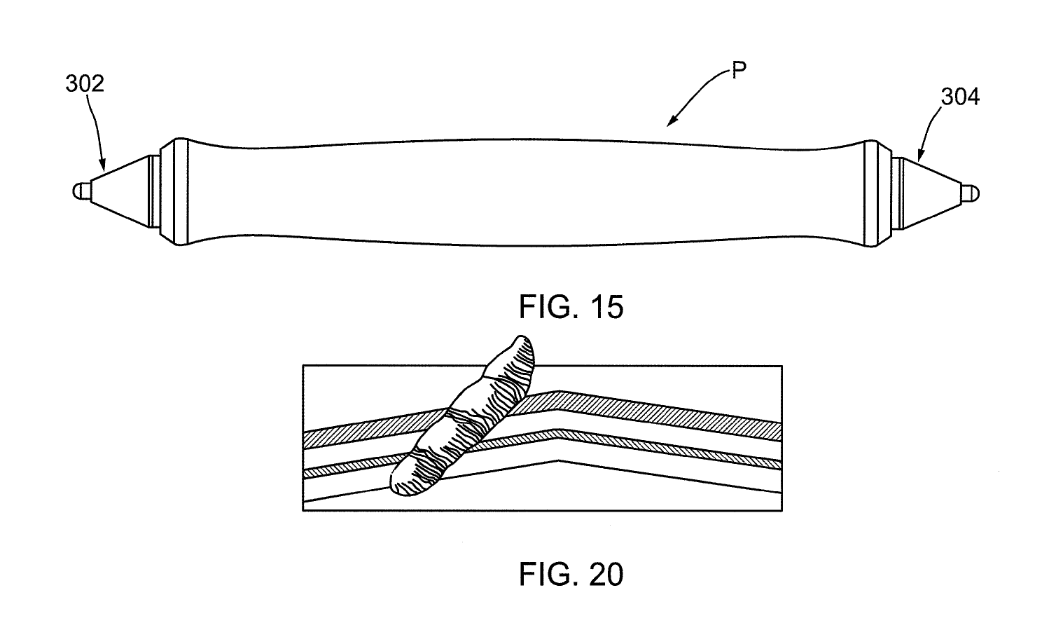

While FIGS. 8 to 14 show an exemplary pen tool, those of skill in the art will appreciate that pen tools P of different configurations can be used in conjunction with the interactive input system 20. For example, FIG. 15 shows an alternative pen tool P wherein tip assemblies 302 and 304 having similar physical geometries are provided at opposite ends of the pen tool body 306. In this case, the modulated signal output by the pen tool P differs depending on the tip assembly that is brought into contact with the display surface 24.

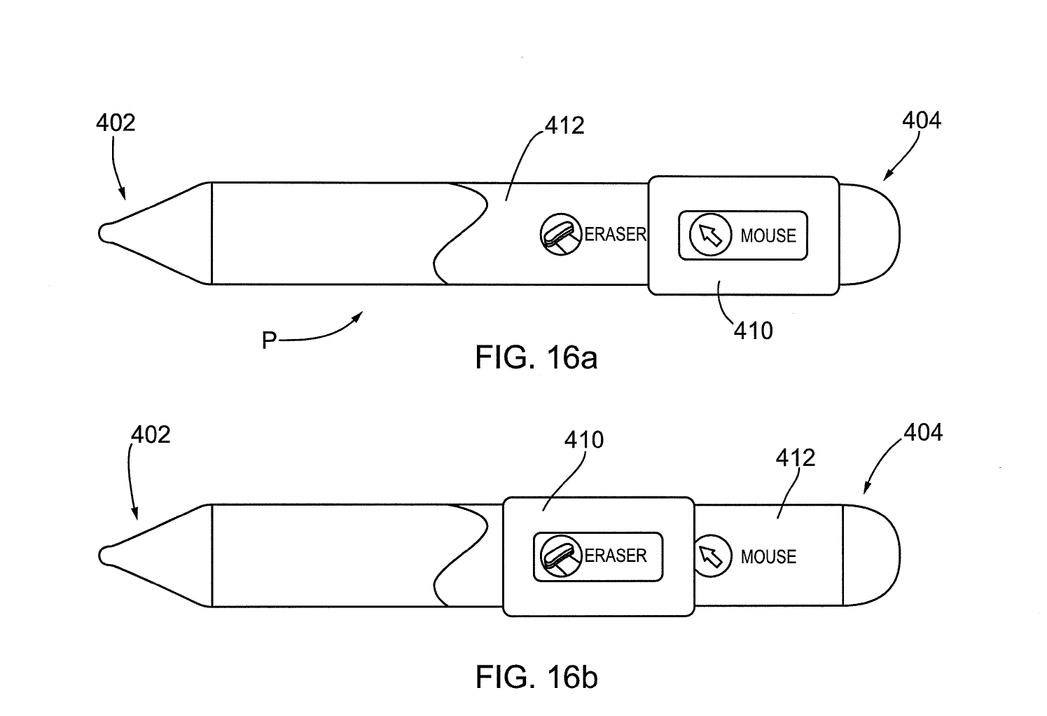

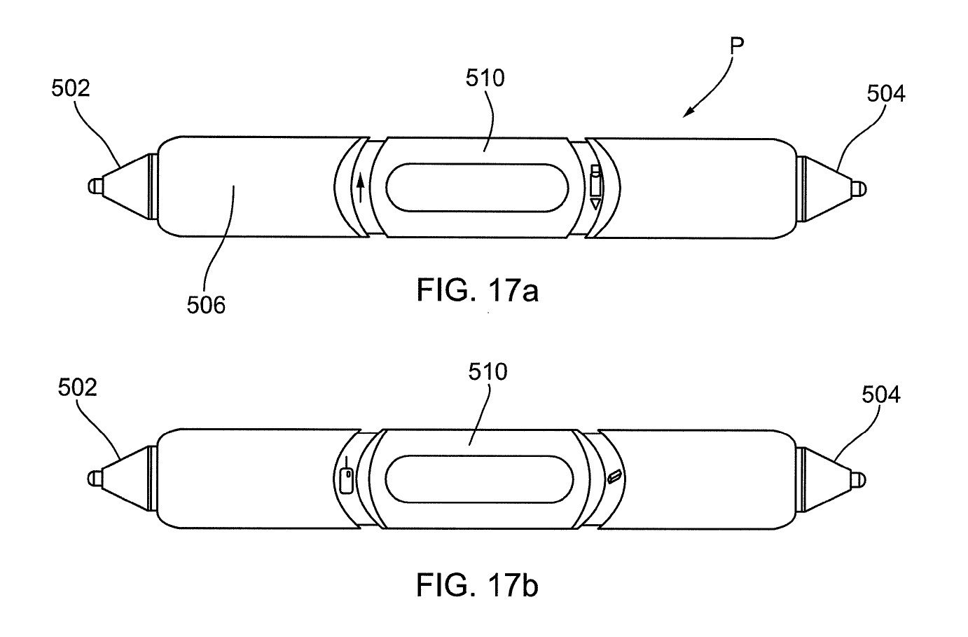

FIGS. 16a and 16b show yet another pen tool P for use in conjunction with the interactive input system 20. In this embodiment, the tip assembly 402 is similar to that in the previous embodiments. The eraser assembly 404 has a more rounded physical configuration. Unlike the previous embodiments, a slider switch 410 that is moveable between mouse and eraser positions is provided on the body 412 of the pen tool P. The position of the slider switch 410 is sensed by the controller 212 and is used to determine the form of the modulated signal that is output by the pen tool P when the eraser assembly 404 is brought into contact with the display surface 24. When the slider switch 410 is positioned in the mouse position as shown in FIG. 16a and the eraser assembly 404 is brought into contact with the display surface 24 with sufficient force to close the switch 254, the pen tool P outputs a modulated signal that is compared to the mapping table by the controller 120 to determine that the pen tool is operating in a pointer mode. The controller 120 in turn assigns pointer mode information to the generated pointer coordinates. Similarly, when the slider switch 410 is positioned in the eraser position as shown in FIG. 14b and the eraser assembly 404 is brought into contact with the display surface with sufficient force to close the switch 254, the pen tool P outputs a differently modulated signal that is compared to the mapping table by the controller 120 to determine that the pen tool is operating in an eraser mode. The controller 120 in turn assigns eraser mode information to the generated pointer coordinates.

FIGS. 17a and 17b show yet another pen tool P for use in conjunction with the interactive input system 20. In this embodiment, tip assemblies 502 and 504 having generally the same physical configuration are provided at opposite ends of the body 506. A slider switch 510 is provided on the body 506 of the pen tool P and is moveable towards the tip assembly 502 between two positions as well as moveable towards the tip assembly 504 between two positions. In particular, the slider switch 510 is moveable towards the tip assembly 502 between ink and eraser positions and towards the tip assembly 504 between select and right click positions. The position of the slider switch 510 is sensed by the controller 212 and used to determine the form of the modulated signal that is output by the pen tool P when a tip assembly is brought into contact with the display surface 24 with sufficient force to close the tip switch assembly 220.

When the slider switch 510 is positioned in the ink position as shown in FIG. 17a and the plunger of the tip assembly 502 is brought into contact with the display surface 24 with sufficient force to close the tip switch assembly 220, the pen tool outputs a modulated signal that is compared to the mapping table by the controller 120 to determine that the pen tool P is operating in an ink mode. The controller 120 in turn assigns ink mode information to the generated pointer coordinates. Similarly, when the slider switch 510 is positioned in the eraser position as shown in FIG. 17b and the plunger of the tip assembly 502 is brought into contact with the display surface 24 with sufficient force to close the tip switch assembly 220, the pen tool outputs a differently modulated signal that is compared to the mapping table by the controller 120 to determine that the pen tool P is operating in an eraser mode. The controller 120 in turn assigns eraser mode information to the generated pointer coordinates. When the slider switch 510 is positioned in the select position as shown in FIG. 17a and the plunger of the tip assembly 504 is brought into contact with the display surface 24 with sufficient force to close the tip switch assembly 220, the pen tool P outputs yet another differently modulated signal that is compared to the mapping table by the controller 120 to determine that the pen tool P is operating in a select mode. The controller 120 in turn assigns select mode information to the generated pointer coordinates. Similarly, when the slider switch 510 is positioned in the right click position as shown in FIG. 17b and the plunger of the tip assembly 504 is brought into contact with the display surface 24 with sufficient force to close this tip switch assembly 220, the pen tool P outputs still yet another differently modulated signal that is compared to the mapping table by the controller 120 to determine that the pen tool is operating in a right click mode. The controller 120 in turn assigns right click mode information to the generated pointer coordinates.

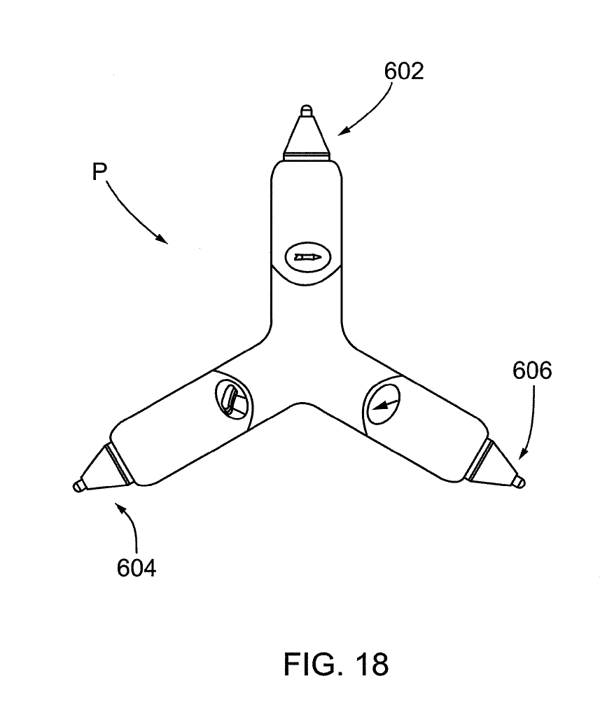

FIG. 18 shows still yet another pen tool P for use in conjunction with the interactive input system 20. In this embodiment, the pen tool P has three tip assemblies 602 and 606, each of which is associated with a different pen tool mode. In particular, in this embodiment, tip assembly 602 is associated with the ink mode, tip assembly 604 is associated with the eraser mode and tip assembly 606 is associated with the select mode. The modulated signal that is output by the pen tool P differs depending on the tip assembly that is brought into contact with the display surface 24.

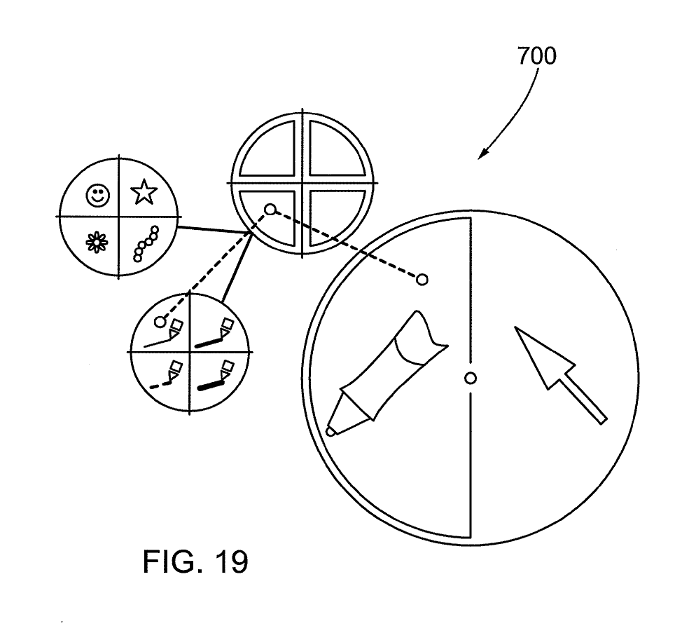

If desired, rather than having the modulated signal-to-pen tool mode mappings in the mapping table statically assigned, the computer 30 can be responsive to user input to present a graphical user interface 700 that presents the mappings visually and allows the user to change the pen tool mode that is associated with each modulated signal output by the pen tools P as shown in FIG. 19.

In addition to using the modulated signal output by the pen tool P to determine the pen tool type (i.e. its mode of operation), an attribute may be assigned to the modulated signal to control further the manner by which the computer 30 processes pointer coordinates. For example, if the user is contacting the display surface 24 with an eraser assembly (or a tip assembly representing an eraser mode) of a pen tool P, an attribute may be assigned to the modulated signal in the mapping table so that only ink that has been input using that specific pen tool P or only ink of a certain color or only ink bounded by a selected geometric shape (e.g. rectangles, circles, squares, etc.) is erased when the pointer coordinates are processed by the computer 30.

As will be appreciated, although specific pen tool modes are described, those of skill in the art will appreciate that alternative pen tool modes or different combinations of pen tools modes can be assigned to the modulated signals output by the pen tools. Although pen tools P with slider switches are illustrated, pen tools with alternative input interfaces can of course be used to allow the user to select the pen tool mode(s). For example, the pen tool P may comprise multiple button switches, a single button switch that toggles through multiple positions, rotating switches, one or more scroll wheels, pressure or orientation sensitive switches etc. with each switch or switch position being associated with a pen tool operation mode. Alternatively, the pen tool P may include a microphone and the controller 212 may execute voice recognition software to enable the pen tool mode to be selected by the user through input voice commands. Haptic commands such as tapping the edge of the display screen 24 may also be used to enable the pen tool mode to be selected.

Although specific embodiments have been described above with reference to the figures, those of skill in the art will appreciate that other alternatives are available. For example, in the above embodiment, the DSP unit 26 is shown as comprising an antenna 136 and a wireless receiver 138 to receive the modulated signals output by the pen tool P. Alternatively, each imaging assembly 60 can be provided with an antenna and a wireless receiver to receive the modulated signals output by the pen tool P. In this case, modulated signals received by the imaging assemblies are sent to the DSP unit 26 together with the image frames. The pen tool P may also be tethered to the assembly 22 or DSP unit 26 allowing the signals output by the pen tool P to be conveyed to one or more of the imaging assemblies 60 or the DSP unit 26 or imaging assembly(s) over a wired connection.

In the above embodiment, discontinuity values D(x) are examined and processed to determine the existence and location of a pointer. Those of skill in the art will appreciate that the VIPᵣₑₜᵣₒ and VIP_{dark} values may be processed directly to determine the existence and location of a pointer.

In an alternative embodiment, the imaging assemblies 60 may look across the display surface 24 such that the reflection of the retro-reflective band 102 appearing on the display surface 24 is captured in image frames and appears in the image frames as a light band spaced from and below the bright band 160. During processing of these image frames, each image frame is separated into three regions, namely a dark region corresponding to the contribution from the IR radiation absorbing bands 104 of the bezel segments, a very bright (retro-reflective) region corresponding to the contribution from the retro-reflective bands 102 of the bezel segments and a bright (reflective) region corresponding to the contribution from the reflection of the retro-reflective bands 102 appearing on the display surface 24.

Once separated, the controller 120 generates VIPs for the individual regions and processes the VIPs to determine if a pointer in proximity with the display surface 24 exists and if so, its position in (x,y) coordinates relative to the display surface 24.

In order to detect a pointer in proximity with the display surface 24, after the VIPs for the dark, retro-reflective and reflective regions have been generated, each VIP value of the dark region VIP is subtracted from its corresponding VIP value of the retro-reflective VIP. Each difference is examined to determine if it is less than a threshold level. If so, the pixel column of the retro-reflective VIP is flagged. Afterwards, a dilation procedure is performed to detect spurious flags. In particular, for each flagged pixel column of the retro-reflective VIP, a check is made to determine whether the pixel columns to its left and right are also flagged. If so, the pixel column is flagged as representing a pointer.

A continuity check is then performed. During the continuity check, each VIP value of the dark region VIP is subtracted from its corresponding VIP value of the reflective VIP. Again each difference is examined to determine if it is less than a threshold level. If so, the pixel column of the reflective VIP is flagged. A dilation similar to that described above is performed with respect to the flagged pixel columns of the reflective VIP. Following this, in order to locate the pointer, the flagged pixel columns of the retro-reflective VIP and the reflective VIP are compared to detect overlapping flagged pixel columns. If overlapping pixel columns are detected, the pixel columns at the boundaries of the overlap in the reflective VIP are deemed to represent the edges of the pointer. The pixel column at the midpoint between the boundary pixel columns is then deemed to represent the location of the pointer in the image frame.

In the above embodiments, each bezel segment 40 to 44 is shown as comprising a pair of bands having different reflective properties, namely retro-reflective and IR radiation absorbing. Those of skill in the art will appreciate that the order of the bands may be reversed. Also, bands having different reflective properties may be employed. For example, rather than using a retro-reflective band, a band formed of highly reflective material may be used. Alternatively, bezel segments comprising more than two bands with the bands having differing or alternating reflective properties may be used. For example, each bezel segment may comprise two or more retro-reflective bands and two or more radiation absorbing bands in an alternating arrangement. Alternatively, one or more of the retro-reflective bands may be replaced with a highly reflective band. When the image frames are separated into different regions and processed, upper regions are particularly useful during processing to detect pointer existence but not necessarily pointer location. As will be appreciated, if the pointer is brought towards the display surface 24 at a sharp angle, its position in an upper band relative to the display surface 24 may differ significantly from the position of the pointer tip in the band proximate to the display surface 24 as shown in FIG. 20.

If desired the tilt of each bezel segment can be adjusted to control the amount of light reflected by the display surface itself and subsequently toward the image sensors 70 of the imaging assemblies 60.

Although the frame assembly is described as being attached to the display unit, those of skill in the art will appreciate that the frame assembly may take other configurations. For example, the frame assembly may be integral with the bezel 38. If desired, the assembly 22 may comprise its own panel to overlie the display surface 24. In this case it is preferred that the panel be formed of substantially transparent material so that the image presented on the display surface 24 is clearly visible through the panel. The assembly can of course be used with a front or rear projection device and surround a substrate on which the computer-generated image is projected.

Although the imaging assemblies are described as being accommodated by the corner pieces adjacent the bottom corners of the display surface, those of skill in the art will appreciate that the imaging assemblies may be placed at different locations relative to the display surface. Also, the tool tray segment is not required and may be replaced with a bezel segment.

Those of skill in the art will appreciate that although the operation of the interactive input system 20 has been described with reference to a single pointer or pen tool P being positioned in proximity with the display surface 24, the interactive input system 20 is capable of detecting the existence of multiple pointers/pen tools that are proximate to the touch surface as each pointer appears in the image frames captured by the image sensors.

Although preferred embodiments have been described, those of skill in the art will appreciate that variations and modifications may be made with departing from the spirit and scope thereof as defined by the appended claims.

What is claimed is:

1. A method comprising:
detecting when an input device is moved across digital content presented on a display surface and comparing at least one attribute assigned to the input device with at least one attribute assigned to the digital content; and
based on the result of the comparison, manipulating the digital content.

2. The method of claim 1 further comprising assigning the at least one attribute to the input device in response to user interaction.

3. The method of claim 2 wherein said input device is an erasing tool and wherein said manipulating comprises erasing digital content.

4. The method of claim 3 wherein said digital content comprises digital ink.

5. The method of claim 4 wherein said erasing comprises erasing digital ink that has an assigned at least one attribute that matches the at least one attribute assigned to said erasing tool.

6. The method of claim 5 wherein the at least one attribute assigned to said erasing tool is selected from (i) digital ink input by a particular input device, (ii) digital ink color, (iii) digital ink shape and (iv) digital ink location on the display surface.

7. The method of claim 3 wherein the at least one attribute assigned to said erasing tool is selected from (i) digital ink input by a particular input device, (ii) digital ink color, (iii) digital ink shape and (iv) digital ink location on the display surface.

8. The method of claim 2 wherein the at least one attribute is assigned to the input device in response to user interaction with a graphical user interface presented on said display surface.

9. The method of claim 8 wherein said input device is an erasing tool and wherein said manipulating comprises erasing digital content.

10. The method of claim 9 wherein said digital content comprises digital ink.

11. The method of claim 10 wherein said erasing comprises erasing digital ink that has an assigned at least one attribute that matches the at least one attribute assigned to said erasing tool.

12. The method of claim 11 wherein the at least one attribute assigned to said erasing tool is selected from (i) digital ink input by a particular input device, (ii) digital ink color, (iii) digital ink shape and (iv) digital ink location on the display surface.

13. The method of claim 1 wherein said input device is a pen tool and wherein said manipulating comprises performing an action involving said digital content.

14. The method of claim 13 wherein said performing is carried out when the pen tool has an assigned at least one attribute that matches the at least one attribute assigned to said digital content.

15. The method of claim 1 further comprising, prior to said detecting, determining input device type, said manipulating being based on both the result of the comparing and the input device type.

16. The method of claim 15 further comprising assigning the at least one attribute to the input device in response to user interaction.

17. The method of claim 15 wherein said input device is an erasing tool and wherein said manipulating comprises erasing digital content.

18. The method of claim 17 wherein said digital content comprises digital ink.

19. The method of claim 18 wherein said erasing comprises erasing digital ink that has an assigned at least one attribute that matches the at least one attribute assigned to said erasing tool.

20. The method of claim 19 wherein the at least one attribute assigned to said erasing tool is selected from (i) digital ink input by a particular input device, (ii) digital ink color, (iii) digital ink shape and (iv) digital ink location on the display surface.

21. The method of claim 20 wherein said determining comprises examining a signal generated by said input device.

22. The method of claim 21 wherein said input device is a tool comprising a writing end and an erasing end, said signal identifying the end of said tool used to move across said digital content.

23. The method of claim 2 wherein said assigning comprises determining when said input device has been brought into proximity with a selection pan or displayed information having an assigned attribute and assigning the attribute of the selection pan or displayed information to the input device.

24. The method of claim 2 wherein the assigned at least one attribute is assigned to all input devices used to move across digital content.

25. The method of claim 2 wherein different attributes are assigned to different input devices used to move across digital content.

26. A non-transitory computer readable medium embodying computer executable instructions, which when executed, carry out the method of:
detecting when an input device is moved across digital content presented on a display surface and comparing at least one attribute assigned to the input device with at least one attribute assigned to the digital content; and
based on the result of the comparison, manipulating the digital content.

27. An apparatus comprising:
memory; and
processing structure communicating with said memory and executing instructions stored therein to cause said apparatus at least to:
detect when an input device is moved across digital content presented on a display surface and compare at least one attribute assigned to the input device with at least one attribute assigned to the digital content; and
based on the result of the comparison, manipulate the digital content.

28. The apparatus of claim 27 further comprising a tool tray accommodating one or more input devices.

29. The apparatus of claim 28 wherein said at least one attribute is assigned to an input device removed from said tool tray in response to user interaction.

30. The apparatus of claim 29 wherein said user interaction is user interaction with a graphical user interface presented on said display surface.
